(19) United States
(12) Patent Application Publication
(10) Pub. No.: US 2014/0125091 A1
(43) Pub. Date: May 8, 2014

(54) Structure for Constructing a Chassis of a Vehicle, Trailer or the Like

(71) Applicant: Jordi NADAL ALOY, Barcelona (ES)

(72) Inventor: Jordi NADAL ALOY, Barcelona (ES)

(21) Appl. No.: 14/068,741

(22) Filed: Oct. 31, 2013

(30) Foreign Application Priority Data
Nov. 2, 2012 (ES) 201231164

(51) Int. Cl. B62D 21/18

(52) U.S. Cl. CPC B62D 21/183
USPC 296/204

(57) ABSTRACT

A structure for constructing a chassis of a vehicle, trailer or the like comprising at least one internally hollow, elongated profile having a polygonal section, which includes a plurality of longitudinal grooves at its sides extending along the entire length of the profile and joint assemblies for coupling the wheels to said elongated profile.

### OBJECT OF THE INVENTION

The purpose of the invention patent application herein is to register a structure for manufacturing a chassis having a number of advantages compared to the known state of the art, the features of which are provided in claim 1, attached hereto.

More specifically, the object of the invention is to protect a structure for constructing a chassis of a vehicle, trailer or similar that can simplify the construction of the aforementioned chassis by essentially using a central profile.

### BACKGROUND OF THE INVENTION

For the past many years, vehicles referred to by the abbreviations ATV, SSV or “buggies” have been available on the market that consist essentially of vehicles intended for agricultural uses, for entertainment and competition on terrain which is often uneven, i.e. preferably to be used off paved roads.

To construct such vehicles, a main chassis which supports the other components is used, such as wheel assemblies that can be defined as the assembly formed by at least the stabiliser or suspension bars, the braking system and the damping system. This chassis is formed by a plurality of profiles and plates that are welded together, such that the construction process is more expensive due to the high number of components (profiles and fixing elements for coupling wheel assemblies) and the steps required for joining and assembling as welding and fixing by threading processes are required. Another drawback is that each chassis requires tools to assemble the aforementioned assembly with the pertinent increase in cost.

In addition, the applicant has no knowledge of an invention that has all the characteristics described herein.

### DESCRIPTION OF THE INVENTION

The invention herein has been developed with the aim of providing a structure that is configured as a novelty within the field of application and resolves the aforementioned drawbacks, further providing other additional advantages that will be apparent from the description attached hereinafter.

It is therefore an object of this invention to provide a structure for constructing a chassis of a vehicle, trailer or similar characterised in that it comprises at least one internally hollow, elongated profile having a polygonal bottom that includes a plurality of longitudinal grooves at its sides extending along the entire length of the profile and joint assemblies for coupling the wheels to said elongated profile.

In a preferred embodiment, fixing the joint assemblies and the elongated profile can be carried out by using a tongue and groove system, such that said joint assembly is amenable to sliding through the longitudinal grooves.

Thanks to said features, manufacturing a chassis can be simplified as only a single profile is required, which makes it possible to reduce notably the time involved in manufacturing and the cost thereof. The fact that a single profile is used facilitates the construction process because only one elongated profile has to be manufactured to be cut to the required dimensions, hence multiple vehicle dimensions can be obtained by simply cutting the elongated profile to different lengths.

It is understood herein that the term “elongated profile” can refer to an elongated body made in one piece or consisting of two or more pieces joined together by fastening means known in the prior art (the fastening means being removable or fixed), such parts being of the same or different dimensions depending on the requirements of the vehicle to be assembled with said structure described above.

Another no less advantageous aspect is that, as it is a hollow profile, electric batteries can be housed inside that can feed the vehicle incorporating this structure.

According to another aspect of the invention, the elongated profile can optionally have an outer wall and an inner wall separate from one another, between which reinforcing ribs are provided, such that rigidity is provided to the elongated profile.

Preferably, the elongated profile of the structure is made of aluminium or an aluminium alloy, such that it facilitates making the profile by means of a continuous process of extrusion.

In a preferred embodiment, the polygonal bottom is substantially rectangular.

Preferably, the grooves have a circular hollow contour although they may also have a dovetail-shaped hollow contour, such that they can be used to secure or be points of rotation for the joint assemblies or other elements or accessories, without prior machining.

In an alternative embodiment of the structure object of this invention, it may comprise internally hollow, elongated profiles that are arranged parallel to each other, said two profiles can be coupled to joint assemblies for coupling the wheels.

Other characteristics and advantages of the structure, object of the invention herein, will become apparent from the description of a preferred, although not exclusive embodiment, which is illustrated by way of non-limiting example in the drawings appended, in which:

### BRIEF DESCRIPTION OF THE DRAWINGS

FIG. 1.—Perspective view of the structure for constructing a vehicle chassis according to the present invention; and

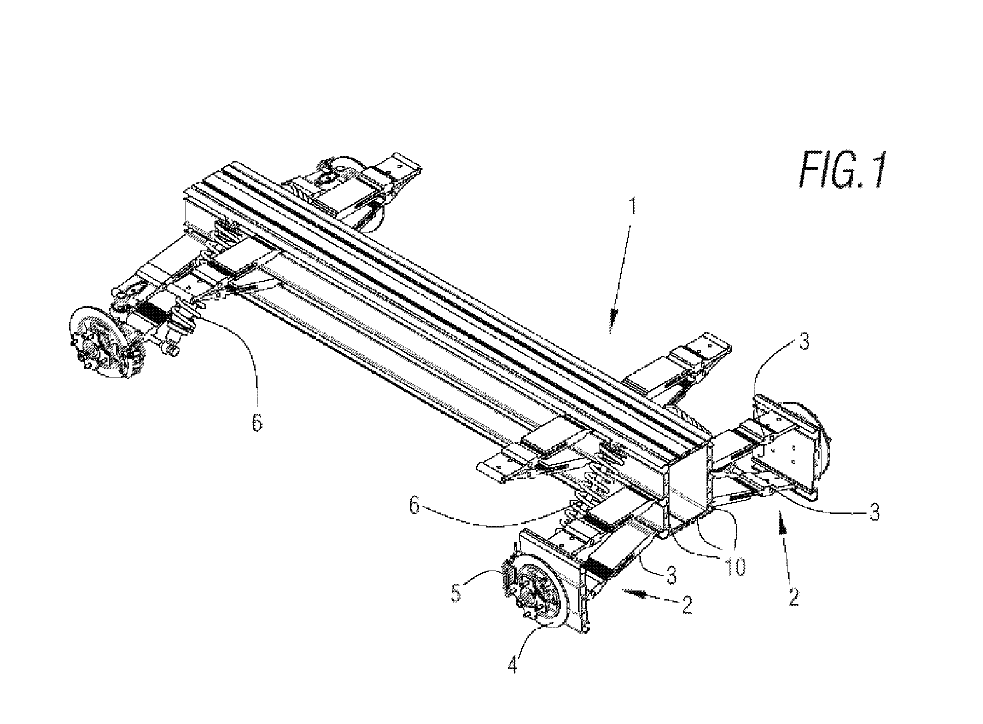

FIG. 2.—Detailed elevation view in a cross section of the structure shown in the previous figure.

### DESCRIPTION OF A PREFERRED EMBODIMENT

In view of the mentioned figures and according to the adopted numbering, an example of a preferred embodiment of the invention can be seen therein, which comprises the parts and elements indicated and described in detail below.

In particular, the structure for constructing a chassis of a vehicle of the type known as SSV comprises an elongated profile (1), made of aluminium, internally hollow, quadrangular in section, which includes a plurality of longitudinal grooves (10) on its sides that extend along the entire length of said profile (1). The frame/body, cargo box or cockpit area is mounted on said profile.

The structure further has four joint assemblies, generally indicated by the reference (2), to facilitate coupling of the wheels (not shown) to said elongated profile, the joint assemblies and the elongated profile being fixed by means of a tongue and groove system that facilitates the assembly process, such that said joint assemblies (2) can slide through said longitudinal grooves (10) to allow the most suitable positioning or in accordance with the requirements of the vehicle to be built. Therefore, the versatility associated with using a profile (1) is evident. It is understood that the number of joint assemblies (2) will depend on the type and size of vehicle to be built, therefore, in other alternative embodiments not shown, more or less four joint assemblies can be provided (2) if it were so required.

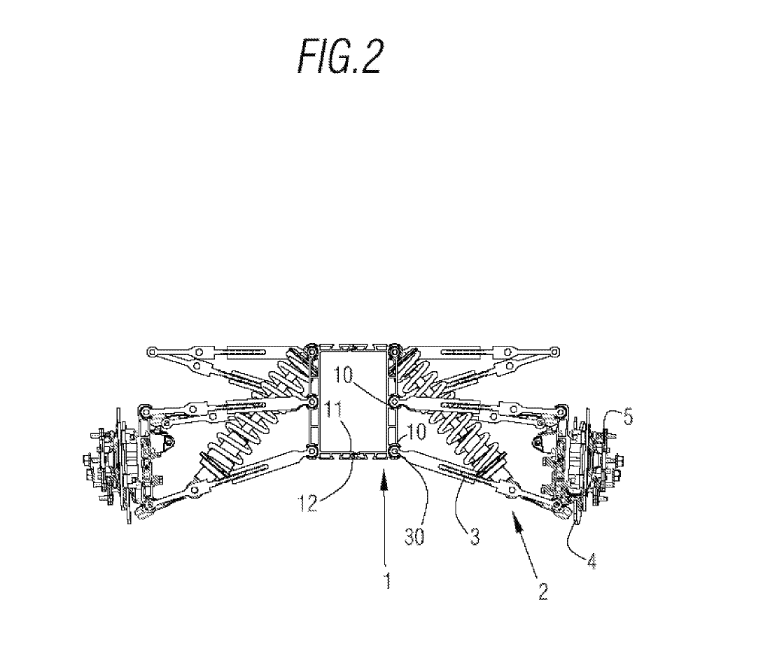

The term “joint assemblies for coupling the wheels” is understood herein as the assembly that comprises stabiliser bars (3) (or part of a trapezoid/parallelogram suspension), braking system formed essentially by the brake disc (4) and corresponding calliper (5) and damping system (6). FIG. 2 shows the tongue and groove system more clearly, in which each one of the stabiliser bars (3) have a number of extensions (30) at their inner end which conform to the contour of the grooves (10).

Of particular note is that said elongated profile (1) has an outer wall (11) and an inner wall (12) spaced apart, between which reinforcing ribs are provided.

Referring again to the aforementioned longitudinal grooves, those that are located at the lateral sides (10) have a circular hollow contour, while the top and bottom of said profile (1) they have a dovetail-shaped hollow contour.

The details, shapes and dimensions and other accessory elements, as well as the materials used in the manufacture of the structure of the invention, may be conveniently exchanged by others which are technically equivalent and do not depart from the essential nature of the invention or from the scope defined by the claims provided hereinafter.

1. A structure for constructing a chassis of a vehicle, trailer or the like, comprising at least one internally hollow, elongated profile having a polygonal section, which includes a plurality of longitudinal grooves at its sides extending along the entire length of the profile and joint assemblies for coupling the wheels to said elongated profile.

2. A structure for constructing a chassis according to claim 1, wherein the joint assemblies and the elongated profile are fixed by a tongue and groove system, such that said joint assembly can slide through the longitudinal grooves.

3. A structure for constructing a chassis according to claim 1, wherein the elongated profile has an outer wall and an inner wall separate from one another, between which reinforcing ribs are provided.

4. A structure for constructing a chassis according to claim 1, wherein the elongated profile is made of aluminium or an aluminium alloy.

5. A structure for constructing a chassis according to claim 1, wherein the polygonal section has a substantially rectangular shape.

6. A structure for constructing a chassis according to claim 2, wherein the grooves have a circular hollow contour.

7. A structure for constructing a chassis according to claim 2, wherein the grooves have a dovetail-shaped hollow contour.

8. A structure for constructing a chassis according to claim 1, comprising two internally hollow, elongated profiles that are arranged parallel to each other, said two profiles can be coupled to joint assemblies for coupling the wheels.
